(19) United States
(12) Patent Application Publication
(10) Pub. No.: US 2010/0152324 A1
(43) Pub. Date: Jun. 17, 2010

(54) COMPOSITION STABILIZED WITH RESPECT TO LIGHT AND/OR HEAT

(75) Inventors: Véronique Bossennec, Serezin du Rhone (FR); Thierry Georges Charbonneaux, Lyon (FR)

Correspondence Address: BUCHANAN, INGERSOLL & ROONEY PC, POST OFFICE BOX 1404, ALEXANDRIA, VA, 22313-1404, US

(73) Assignee: RHODIANYL, Paris La Defense Cedex (FR)

(21) Appl. No.: 12/715,180

(22) Filed: Mar. 1, 2010

Related U.S. Application Data
(62) Division of application No. 10/576,529, filed on Mar. 14, 2007.

(30) Foreign Application Priority Data
Oct. 20, 2003 (FR) 0312242

(51) Int. Cl. C08K 9/04; C08K 5/17; C08K 5/3435; C08K 5/56; C08K 3/32; C08K 3/34; C08K 3/00

(52) U.S. Cl. 523/200; 524/714; 524/779; 524/718; 524/780; 524/706; 524/789

(57) ABSTRACT

The present invention relates to a polyamide-based composition stabilized with respect to light and/or heat comprising at least one stabilizer exhibiting at least one hindered amine functional group. The invention also relates to yarns, fibres, filaments and/or articles obtained from this composition.

The present invention relates to a polyamide-based composition stabilized with respect to light and/or heat comprising at least one stabilizer exhibiting at least one hindered amine functional group. The invention also relates to yarns, fibres, filaments and/or articles obtained from this composition.

Polyamide is a synthetic polymer widely used for the manufacture of yarns, fibres and filaments. These fibres, yarns and filaments are subsequently used for the preparation of textile surfaces and in particular of dyed textile surfaces.

Polyamide can experience damage when it is subjected to external conditions or elements, such as UV radiation, heat and bad weather. Damage can also be induced by the heat used during its manufacture and/or its forming. This instability is reflected by damage, losses in mechanical properties, changes in colour and inhomogeneities. These problems may become critical in a number of applications.

It is known, to improve the stability of polyamides, to combine them with additives. They are often categorized by their method of action: antioxidant, UV stabilizer, UV absorbers and the like. In particular, antioxidants exhibiting hindered phenol units and phosphorus-comprising stabilizers are known to stabilize polyamide.

There is a continual search for novel additives or for novel combinations of stabilizing additives for polyamide in order to enhance the properties of stability with respect to light and heat.

The present invention relates to a composition based on a polyamide matrix comprising at least one light and/or heat stabilizer comprising at least one hindered amine functional group and at least one compound which is:
titanium dioxide; and/or
a manganese compound.

The compositions according to the invention exhibit good stability with respect to light and/or heat. The resistance to heat and/or light of the stabilized polyamide composition of the invention makes possible in particular better uniformity of the dye, the maintenance of the mechanical properties and better retention of the dye over time (ageing). It is observed in particular that the physical and chemical properties of the stabilized polyamide composition according to the invention are not damaged after a heat treatment, such as a heat-setting treatment, which the yarns, fibres, filaments and/or articles are subjected to, before or after the dyeing cycles.

The various compounds can be added in the synthesis of the polyamide. Such a process makes it possible, inter alia, to obtain very good dispersion of the additives in the polyamide and to sometimes avoid operations in which the said polyamide is remelted. Furthermore, the introduction of the stabilizers in the synthesis makes it possible to prevent damage during the manufacture of the polyamide and/or during its forming.

Furthermore, the compositions according to the invention make it possible to obtain textile articles having excellent dye retention. Moreover, little or nothing in the way of visual defects due to poor dye uniformity is observed with regard to the articles obtained. This advantage with the compositions of the invention is obtained in particular when a heat-setting stage has been carried out on non-desized textile articles.

There exist numerous stabilizers comprising at least one hindered amine functional group known to a person skilled in the art. The stabilizer according to the invention comprising at least one hindered amine functional group is preferably chosen from the group consisting of: 4-amino-2,2,6,6-tetramethylpiperidine (TAD), 4-carboxy-2,2,6,6-tetramethylpiperidine and aromatic compounds of formula (I):

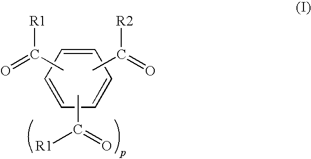

in which p is equal to 0 or 1 and R1 and R2 are identical or different, saturated or unsaturated, substituted or unsubstituted, aromatic and/or aliphatic, optionally cyclic, hydrocarbon groups preferably comprising from 5 to 20 carbon atoms, at least one of which exhibits a hindered amine functional group. In addition to the amine functional group, the R1 and/or R2 groups can comprise heteroatoms, such as nitrogen and/or oxygen.

The compounds of formula (I) thus comprise two or three carbonyl functional groups and comprise at least one group exhibiting a hindered amine functional group, the said functional group being included in a group bonded to one of the carbonyl functional groups. The carbonyl functional group can be included in an amide, ester or ester-amide group.

If p is equal to 0, the additive can have a chemical structure (II) or (III), which are defined as follows:

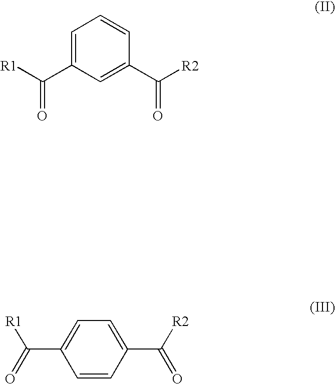

in which R1 or R2 are identical or different groups, at least one of which exhibits a hindered amine functional group, it being possible for a group not comprising a sterically hindered amine functional group to be chosen from C₁ to C₁₈ alkoxys; aminoalkyls optionally substituted by hydrogen, C₁ to C₅ alkoxys, carbonyl groups, carbamoyl groups or alkoxycarbonyl groups; or C₃ to C₅ epoxides; it being possible for the group or groups comprising a sterically hindered amine functional group to be chosen from the following compounds of formula (IV):

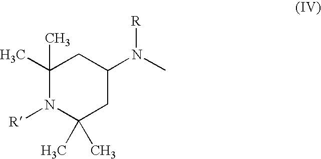

in which R and R′ are chosen independently from hydrogen, C₁ to C₁₂ alkyls, C₁ to C₈ alkoxys, groups with the structure —COR3, where R3 is chosen from hydrogen or C₁ to C₆ alkyls; phenyl; the —COO(C₁ to C₄ alkyl) group; the group with the structure NR5R6, where R5 and R6 are chosen independently from hydrogen, C₁ to C₁₂ alkyls, Cₛ or C₆ cycloalkyls, phenyl, alkylphenyls, the alkyl of which is a C₁ to C₁₂ alkyl, or R5 and R6 form, with the nitrogen atom to which they are bonded, a 5- to 7-membered ring optionally comprising an oxygen atom or another nitrogen atom, preferably forming a group from the family of the piperidines or morpholines.

A preferred compound for the light stabilizer is the compound of formula (V):

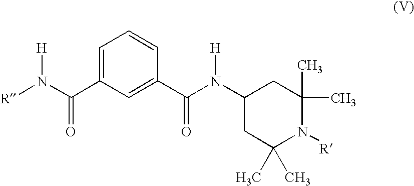

in which R″ is chosen from C₁ to C₂₀ alkyls, C₁ to C₂₀ aminoalkyls, substituted C₁ to C₂₀ aminoalkyls, C₁ to C₂₀ hydroxyalkyls, C₁ to C₂₀ alkenyls, substituted C₁ to C₂₀ alkenyls, alkoxyalkyl groups, C₁₋₂₀-oxy-N—C₁₋₂₀-alkyl groups, —N-cycloalkyl groups comprising 1 to 10 carbon atoms, —N-cycloalkyl groups comprising 1 to 10 carbon atoms substituted by a —COR4 group where R4 is chosen from hydrogen, C₁ to C₆ alkyls, phenyl, C₁₋₂₀COO(H or C₁₋₄alkyl) groups, and where R′ has the same meaning as for the formula (IV).

The light stabilizer is more preferably still the compound of formula (VI):

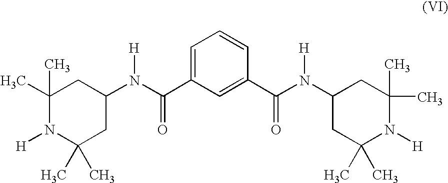

This additive is, for example, supplied by Clariant under the name Nylostab S-EED.

The composition of the invention can comprise from 0.05% to 0.5% by weight of light and/or heat stabilizer comprising at least one hindered amine functional group, with respect to the total weight of the composition, preferably from 0.1 to 0.3% by weight.

The composition according to the invention can comprise titanium dioxide.

The titanium dioxide can be a titanium dioxide particle, optionally in the crystalline form. The crystalline titanium dioxide can be of anatase and/or rutile type. Preferably, the crystalline nature of the titanium dioxide is predominantly anatase, which means that the level of anatase in the titanium compound is greater than 50% by weight, preferably 80% by weight.

The composition according to the invention can comprise from 0.01% to 3% by weight, preferably from 0.02 to 2% by weight, more preferably from 0.3 to 2% by weight, of titanium dioxide with respect to the total weight of the composition. The titanium dioxide particles can exhibit a mean size of less than 0.1 μm, preferably a mean size of between 0.2 and 0.4 μm.

It is possible to dope the crystal lattice of the titanium dioxide by incorporating therein at least one metal ion, such as, for example, antimony.

The titanium dioxide particles can optionally be subjected beforehand to an organic treatment, in particular to help in their dispersibility, for example starting from polyols, polyglycols, polyethers, organic esters (such as dioctyl azelate) and/or trimethylolpropane.

Preferably, the titanium dioxide used according to the invention, when it is provided in the form of particles, does not, comprise an inorganic coating. It is known that the titanium dioxide particles used in polyamides for yarn, fibre or filament applications are generally coated with inorganic compounds, such as silica and/or alumina, at levels of element (silicon and/or aluminium) of between 0.3 and 0.75% by weight, with respect to the total weight of the particle. Use will preferably be made of titanium dioxide particles comprising less than 0.2% by weight, preferably less than 0.1% by weight, of silicon and/or of aluminium (element).

The presence of titanium in the composition can be determined by elemental analysis, such as, for example, by X-ray fluorescence. The presence of titanium dioxide in the composition can be determined by X-ray diffraction, so as to demonstrate the crystalline aspect of the titanium dioxide. The presence of titanium dioxide particles uncoated by one or more inorganic compounds in the composition according to the invention can be demonstrated in the following way: elemental analysis, such as, for example, by ICP (Inductive Coupled Plasma), on a digested product in order to determine the presence of titanium, silicon and/or aluminium elements. The proportion of titanium can be correlated with that of silicon and/or aluminium in order to determine the presence or the absence in the composition of coated or uncoated titanium dioxide particles.

The composition according to the invention can comprise a manganese compound. This manganese compound can be a manganese salt, for example obtained from an inorganic and/or organic acid.

The manganese salts are preferably chosen from the group consisting of: manganese oxalate, manganese lactate, manganese benzoate, manganese stearate, manganese acetate, manganese hypophosphite, manganese silicate, manganese pyrophosphate and manganese chloride, preferably manganese acetate. Preferably, manganese acetate tetrahydrate (CAS: 6156-78-1) is used.

The composition according to the invention can comprise from 5 to 100 ppm (mg per kilo of polyamide) of manganese compound, the said concentration being expressed as manganese element, preferably from 5 to 50 ppm. The proportion of manganese element in the composition can be measured by elemental analysis, such as, for example, analysis by X-ray fluorescence or ICP (Inductive Coupled Plasma).

The polyamide matrix of the invention can be based on a polyamide of the type of those obtained by polymerization starting from a lactam and/or from an amino acid or based on a polyamide of the type of those obtained by polycondensation of a dicarboxylic acid and of a diamine. The polyamide matrix can comprise a (co)polyamide chosen from the group consisting of: polyamide 6, polyamide 66, polyamide 11, polyamide 12, copolyamide 4-6, copolyamide 6-66, copolyamide 6-10, copolyamide 6-12, copolyamide 12-12 and their blends and copolyamides. The polyamide composition can be based on or can comprise star or branched polyamides, such as those mentioned in Applications WO 97/24388 or EP 1 086 161.

The (co)polyamide can exhibit a content of amine terminal groups (ATG) of between 35 and 75 meq/kg, preferably between 35 and 50 meq/kg.

The stabilized polyamide-based composition can comprise other additives, in addition to the additives already mentioned. These additives can be introduced before, during or after the polymerization or by melt blending. Mention may be made, as examples of such additives, of pigments or mattifying agents intended to confer a matt and/or coloured appearance on the compositions, flame retardants, other stabilizers, such as antioxidants, such as phenolic antioxidants, UV stabilizers, UV absorbers and phosphorus-comprising stabilizers, antimicrobial agents, antifoaming agents and processing aids.

Various methods can be used to manufacture the composition according to the invention. Use may in particular be made of a process for the manufacture of a stabilized polyamide composition in which at least one light and/or heat stabilizer comprising at least one hindered amine functional group and at least:
titanium dioxide; and/or
one manganese compound;
   are introduced in the base monomers of the polyamide, before or during the polymerization step.

A light and/or heat stabilizer comprising at least one hindered amine functional group, such as the compound of formula (VI), and titanium dioxide can in particular be introduced in polymerization. A light and/or heat stabilizer comprising at least one hindered amine functional group, such as the compound of formula (VI), and a manganese compound, such as manganese acetate, can also be introduced in polymerization.

The present invention also relates to a polyamide composition capable of being obtained by the process described above.

The process for the manufacture of the polyamide according to the invention can be chosen from any known process, provided that the various compounds mentioned above are introduced into the polymerization medium before or during the polymerization step. It is possible for a product exhibiting a low degree of polycondensation to be formed before the introduction of the additives. The various compounds mentioned above can be introduced into the polymerization medium either successively, at various stages of the process before the polymerization step, or at the same time.

The titanium dioxide particles can be introduced either in the form of an aqueous suspension or as a mixture with caprolactam and water.

An advantageous manufacturing process uses, as starting material, a hexamethylenediammonium adipate salt, preferably in the form of a solution at salt concentrations of between 50 and 70% by weight, in order to form a polyamide 66. This continuous or batchwise process can comprise a first step of evaporation of the water and a second step of polymerization by polycondensation.

It is also possible to use, as starting material, ε-polycaprolactam, in order to form a polyamide 6. This continuous or batchwise process can comprise a first step of ring opening, a step of polyaddition and of polycondensation, a step of granulation and, finally, a step of washing the granules.

Various chain-limiting or -extending compounds, such as monoacids, diacids, monoamines and/or diamines, can be added to the base monomers of the polyamide before or during the polymerization of the polyamide. For example, acetic acid, benzoic acid, propionic acid, isophthalic acid, terephthalic acid, adipic acid and/or hexamethylenediamine can be added.

The present invention also relates to articles, optionally textile articles, such as yarns, fibres and/or filaments, obtained by forming the composition according to the invention.

The compositions of the invention can be formed into yarns, fibres and/or filaments directly after the polymerization, without intermediate solidification and remelting stages. They can also be formed into granules intended to be subjected to remelting for subsequent definitive forming, for example in the manufacture of moulded articles or in the manufacture of yarns, fibres or filaments.

The yarns, fibres and/or filaments formed from compositions according to the invention are produced by melt spinning: the composition is extruded in the molten state through spinnerets comprising one or more orifices.

Any melt spinning process can be used.

The processes mentioned for the manufacture of multifilament yarns are spinning or spinning-drawing or spinning-drawing-texturing processes which are or are not integrated, whatever the spinning rate. The yarns can be produced by high-speed spinning, at a spinning rate of greater than 3500 m/min. Such processes are often denoted by the following terms: POY (partially oriented yarn), FOY (fully oriented yarn) or ISD (integrated spinning-drawing).

For the manufacture of fibres, the filaments can, for example, be gathered together in the form of a roving or lap, directly after spinning or in a subsequent operation, drawn, textured and chopped. The fibres obtained can be used for the manufacture of nonwovens or staple fibre yarns.

The yarns, fibres and/or filaments of the invention can be subjected to various treatments, such as, for example, drawing in a continuous stage or in a subsequent operation, the deposition of sizing agent, oiling, braiding, texturing, crimping, setting or relaxing heat treatment, throwing, twisting and/or dyeing.

The present invention also relates to textile articles comprising at least yarns, fibres and/or filaments as described above. The term “textile article” is understood to mean in particular any type of fabric, such as woven, nonwoven, knitted, tufted, felted, needled-bonded, stitch-bonded or flocked textile surfaces or textile surfaces produced by another manufacturing method.

The yarns, fibres and/or filaments and the articles obtained from the yarns, fibres and/or filaments can be dyed. The dyeing processes mentioned are in particular bath or jet dyeing processes. The preferred dyes are metalliferous or nonmetalliferous acid dyes.

A specific language is used in the description so as to facilitate the understanding of the principle of the invention. Nevertheless, it should be understood that no excessive limitation on the scope of the invention is envisaged by the use of this specific language. Modifications, improvements and refinements can in particular be envisaged by a person conversant with the technical field concerned on the basis of his own general knowledge.

The term “and/or” includes the meanings “and”, “or” and all the other possible combinations of the elements connected to this term.

Other details or advantages of the invention will become more clearly apparent in the light of the examples given below solely by way of indication.

### EXAMPLE 1

### Polyamide 66 Composition According to the Invention

A copolymer based on polyamide 66 is manufactured from 1115 kg of a 52% by weight concentrated aqueous solution of a hexamethylenediammonium adipate salt, to which are added:
58 g of manganese acetate tetrahydrate (Aldrich reference: 22, 100-7);
20 g of Rhodorsil 411 antifoaming agent;
12.9 kg of caprolactam;
780 g of Nylostab S-EED from Clariant;
257 g of adipic acid; and
8.8 kg of uncoated TiO₂ (Hombitan LWS from Sachtleben).

The polyamide is manufactured according to the standard process comprising a stage of concentrating the solution in an evaporator and a polycondensation stage in a stirred autoclave reactor, with a distillation step of approximately 100 min at a stationary pressure of 18.5 bar for which the final temperature is 267° C., a step of decompression of approximately 25 min from 18.5 bar to 1 bar with a final temperature of 269° C. and a finishing step of approximately 26 min for which the final temperature is 278° C.

During the step of distillation under pressure, 44.2 kg of a 20% by weight aqueous dispersion of uncoated titanium oxide particles are added after 25 min.

A copolymer based on polyamide 66 comprising 2.5% by weight of polyamide 6 units and 1.7% by weight of titanium dioxide is obtained.

### COMPARATIVE EXAMPLE 2

### Polyamide 66 Composition

A control polyamide 2C is obtained according to the same process starting from the following base materials: a copolymer based on polyamide 66 is manufactured from 1115 kg of a 52% by weight concentrated aqueous solution of a hexamethylenediammonium adipate salt, to which are added:
58 g of manganese acetate tetrahydrate (Aldrich reference: 22, 100-7);
20 g of Rhodorsil 411 antifoaming agent;
13 kg of caprolactam;
120 g of acetic acid; and
8.8 kg of uncoated TiO₂ (Hombitan LWS from Sachtleben).

A copolymer based on polyamide 66 comprising 2.5% by weight of polyamide 6 units and 1.7% by weight of titanium dioxide is obtained.

### COMPARATIVE EXAMPLE 3

### Polyamide 66 Composition

A control polyamide 3C is obtained according to the same process starting from the following base materials: a copolymer based on polyamide 66 is manufactured from 1115 kg of a 52% by weight concentrated aqueous solution of a hexamethylenediammonium adipate salt, to which are added:
20 g of Rhodorsil 411 antifoaming agent;
13 kg of caprolactam;
120 g of acetic acid; and
8.8 kg of TiO₂ coated with silica and alumina (Hombitan LOCR-SM from Sachtleben).

A copolymer based on polyamide 66 comprising 2.5% by weight of polyamide 6 units and 1.7% by weight of titanium dioxide is obtained.

### EXAMPLE 4

### Polyamide 66 Composition

A control polyamide 4C is obtained according to the same process starting from the following base materials: a copolymer based on polyamide 66 is manufactured from 1115 kg of a 52% by weight concentrated aqueous solution of a hexamethylenediammonium adipate salt, to which are added:
20 g of Rhodorsil 411 antifoaming agent;
12.9 kg of caprolactam;
780 g of Nylostab S-EED from Clariant;
257 g of adipic acid; and
8.8 kg of TiO₂ coated with silica and alumina (Hombitan LOCR-SM from Sachtleben).

A copolymer based on polyamide 66 comprising 2.5% by weight of polyamide 6 units and 1.7% by weight of titanium dioxide is obtained.

### EXAMPLE 5

### Spinning and Knitting the Polyamide Compositions

The polyamide compositions obtained in the preceding examples are spun with a wind-up speed of 4200 m/min and are then drawn with a wind-up speed of 1070 m/min. The count of the yarns obtained is 101 dtex per 68 filaments before drawing and 82 dtex after drawing.

For the polyamide 1: the tenacity of the POY yarn before drawing is 34.8 cN/tex and the elongation at break is 75.9%. The tenacity of the drawn yarn is 43.9 cN/tex and the elongation at break is 43.3%.

For the control polyamide 2C: the tenacity of the POY yarn before drawing is 34.5 cN/tex and the elongation at break is 74.2%. The tenacity of the drawn yarn is 43.3 cN/tex and the elongation at break is 43.9%.

For the control polyamide 3C: the tenacity of the POY yarn before drawing is 33.9 cN/tex and the elongation at break is 77%. The tenacity of the drawn yarn is 42.1 cN/tex and the elongation at break is 44.2%.

For the control polyamide 4C: the tenacity of the POY yarn before drawing is 34.2 cN/tex and the elongation at break is 76.3%. The tenacity of the drawn yarn is 42.4 cN/tex and the elongation at break is 44.6%.

5 knitted surfaces are prepared from the 5 yarns described above. Each knitted surface comprises one type of yarn.

### EXAMPLE 6

### Heat-Setting

The textile surfaces obtained in Example 5 are subsequently heat-set at 195° C. for 45 seconds.

The viscosity number and the level of amine groups before and after heat-setting are measured according to the analytical methods described:

TABLE I

| | VN of the | | | |
|---|---|---|---|---|
| | yarn | ATG | ΔVN | ΔATG |
| Examples | (ml/g) | (meq/kg) | (ml/g) | (meq/kg) |
| 1 | 129.3 | 44.9 | −0.2 | −1 |
| 2C | 129.4 | 41.4 | −3.1 | −8 |
| 3C | 128.4 | 41.7 | −14 | −9 |
| 4 | 126.4 | 45.7 | −3 | −7 |

### Determination Method:

VN of the yarn (ml/g): the POY yarn is dissolved in 90% formic acid at a concentration of 0.5% weight/volume. The viscosity measurement is carried out at 25° C. with a Ubbelohde tube with a diameter of 0.63 mm according to Standard ISO 307.
ATG: the amine groups are determined by potentiometric titration with 0.1N hydrochloric acid of 2 g of POY yarn dissolved in 70 ml of phenol (90%) at 40° C. for 5 hours.
ΔVN after heat-setting: the difference between the VN of the knitted fabric after heat-setting and the VN of the knitted fabric before heat-setting (i.e. VN of the POY yarn) is determined.
ΔATG (meq/kg): the difference between the ATG level of the knitted fabric after heat-setting and the ATG level of the knitted fabric before heat-setting (i.e. VN of the POY yarn) is determined.

### EXAMPLE 7

### Polyamide 66 Composition According to the Invention and Heat-Setting Tests

A copolymer based on polyamide 66 is manufactured from 3148 g of a 52% by weight concentrated aqueous solution of a hexamethylenediammonium adipate salt, to which are added:
1.45 g of manganese acetate tetrahydrate (Aldrich reference: 22, 100-7);
78.7 g of caprolactam;
0.61 g of acetic acid;
0.1 g of Rhodorsil 411 antifoaming agent;
14 g of Nylostab S-EED from Clariant; and
200 g of a 20% aqueous suspension of various TiO₂ types (see Table II).

The polyamide is manufactured according to the standard process described above in a 7.5 litre reactor with a finishing time of approximately 40 minutes.

The polyamide is cryogenically ground (100-200 μm) and then a heat-setting test is carried out on the powder at 200° C. for 5 minutes. The variation in the viscosity number before and after heat-setting is subsequently measured with the analytical methods described above.

TABLE II

| Examples | TiO₂ type | ΔVN (ml/g) |
|---|---|---|
| 7.1 | LWS | 4.28 |
| 7.2 | LWS-U | 4.8 |
| 7.3 | LWSU-HD | 4.8 |
| 7.4 | APP2 | −7 |

The TiO₂ particles used exhibit the following characteristics:
Hombitan LWS (Sachtleben): no inorganic coating/no organic coating/no doping of the crystal
Hombitan LWS-U (Sachtleben): no inorganic coating/no organic coating/doping of the crystal with antimony
Hombitan LWSU-HD (Sachtleben): no inorganic coating/organic coating/doping of the crystal with antimony
APP2 (Huntsman): inorganic coating/organic coating/no doping of the crystal

### EXAMPLE 8

### Light Stability

The drawn yarns of Examples 1 and C2 are knitted. The surfaces obtained are subjected as is without desizing and without dyeing to a Xenotest (Xenotest 150S, Hanau, chamber/temperature of the black panel of 45° C./relative humidity of 60%).

TABLE III

| | Tensile strength (cN/tex)* | | | |
|---|---|---|---|---|
| Examples | T = 0 | T = 1 week | T = 2 weeks | T = 4 weeks |
| 2C | 52 | 46 | 38 | 30 |
| 1 | 53 | 52 | 49 | 40 |

*mean over 6 tests

1.-15. (canceled)

16. A method for improving thermal stability of a composition based on a polyamide matrix, comprising adding at least one light and/or heat stabilizer comprising at least one hindered amine functional group, titanium dioxide, and a manganese compound, in the base monomers of the polyamide, before or during a polymerization step.

17. The method according to claim 16, wherein the stabilizer is selected from the group consisting of: 4-amino-2,2,6,6-tetramethylpiperidine, 4-carboxy-2,2,6,6-tetramethylpiperidine and an aromatic compound of formula (I): 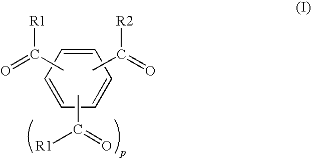
in which p is equal to 0 or 1 and R1 and R2 identical or different are hydrocarbon groups, at least one of which having a hindered amine functional group.

18. The method according to claim 16, wherein the light stabilizer is the compound of formula (VI):

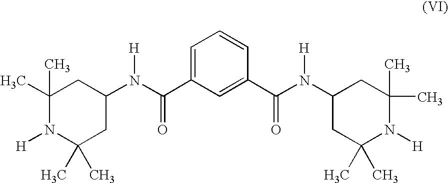

19. The method according to claim 16, comprising adding 0.05% to 0.5% by weight of light and/or heat stabilizer, with respect to the total weight of the composition.

20. The method according to claim 16, wherein the titanium dioxide is a titanium dioxide particle in the crystalline form.

21. The method according to claim 16, wherein the titanium dioxide is a titanium dioxide particle not having an inorganic coating.

22. The composition according to claim 16, comprising adding 0.01% to 3% by weight of titanium dioxide, with respect to the total weight of the composition.

23. The method according to claim 16, wherein the manganese compound is a manganese salt obtained from an inorganic and/or organic acid.

24. The method according to claim 23, wherein the manganese salt is selected from the group consisting of: manganese oxalate, manganese lactate, manganese benzoate, manganese stearate, manganese acetate, manganese hypophosphite, manganese silicate, manganese pyrophosphate and manganese chloride.

25. The method according to claim 16, comprising adding 5 to 100 ppm of manganese compound, said concentration being expressed as manganese element.

26. The method according to claim 16, wherein the polyamide matrix comprises a (co)polyamide selected from the group consisting of: polyamide 6, polyamide 66, polyamide 11, polyamide 12, copolyamide 4-6, copolyamide 6-66, copolyamide 6-10, copolyamide 6-12, copolyamide 12-12, and their blends and copolyamides.

27. The method according to claim 16, wherein: the stabilizer is selected from the group consisting of: 4-amino-2,2,6,6-tetramethylpiperidine, 4-carboxy-2,2,6,6-tetramethylpiperidine and an aromatic compound of formula (I): 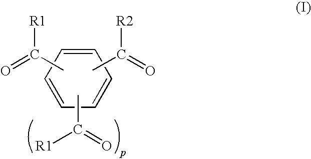
in which p is equal to 0 or 1 and R1 and R2 identical or different are hydrocarbon groups, at least one of which having a hindered amine functional group; the titanium dioxide is a titanium dioxide particle in the crystalline form; the manganese salt is selected from the group consisting of: manganese oxalate, manganese lactate, manganese benzoate, manganese stearate, manganese acetate, manganese hypophosphite, manganese silicate, manganese pyrophosphate and manganese chloride; and the polyamide matrix comprises a (co)polyamide selected from the group consisting of: polyamide 6, polyamide 66, polyamide 11, polyamide 12, copolyamide 4-6, copolyamide 6-66, copolyamide 6-10, copolyamide 6-12, copolyamide 12-12, and their blends and copolyamides.
